(19) United States
(12) Patent Application Publication
(10) Pub. No.: US 2019/0323171 A1
(43) Pub. Date: Oct. 24, 2019

(54) TEXTILE STRUCTURE

(71) Applicant: Sabrina Fashion Industrial Corp., New Taipei City (TW)

(72) Inventor: Yu-Ming Hsu, New Taipei City (TW)

(73) Assignee: Sabrina Fashion Industrial Corp., New Taipei City (TW)

(21) Appl. No.: 15/959,269

(22) Filed: Apr. 22, 2018

(51) Int. Cl. D06N 3/00; B32B 3/26; D06N 3/14; A41D 31/00

(52) U.S. Cl. CPC D06N 3/005; B32B 3/266; A41D 2400/22; A41D 31/00; D06N 3/14

(57) ABSTRACT

A textile structure is provided, including a water swellable layer and a water permeable film layer. The water swellable layer has a first surface and a second surface opposite to each other, and has at least one fixing portion, at least one movable sheet and at least one incision which passes through the first surface and the second surface. The water permeable film layer is disposed on the second surface of the water swellable layer corresponding to the movable sheet, wherein at least part of the water permeable film layer extends to the incision. The movable sheet curls and stretches away from the second surface due to water swellable properties when the water swellable layer absorbs water, so as to form apertures in the water swellable layer.

### BACKGROUND

### Technical Field

The invention is related to a textile structure, and more particularly, to a textile structure capable of controlling fabric apertures by humidity variation.

### Description of Related Art

In recent years, fitness has become a popular trend around the world. With the progress and advance of science and technology, the ventilation of sports clothing has become more and more important. Generally, the ventilation of sports clothing improves wearing comfort during exercise, but it's harder for the wearer to stay warm during rest. However, it is unable to adjust the ventilation in most of the traditional sports clothing in response to wearer's condition during exercise or rest.

Based on the above, a textile structure capable of adjusting the ventilation in response to wearer's condition is urgently needed, such that the wearing comfort can be improved during exercise and the wearer is able to stay warm during rest.

### SUMMARY

The invention provides a textile structure capable of controlling fabric apertures by humidity variation, so as to adjust the ventilation in response to wearer's condition. Therefore, the wearing comfort can be improved during exercise and the wearer is able to stay warm during rest.

The invention provides a textile structure including a water swellable layer and a water permeable film layer. The water swellable layer has a first surface and a second surface opposite to each other, and has at least one fixing portion, at least one movable sheet and at least one incision which passes through the first surface and the second surface. The water permeable film layer is disposed on the second surface of the water swellable layer corresponding to the movable sheet, wherein at least part of the water permeable film layer extends to the incision. The movable sheet curls and stretches away from the second surface due to water swellable properties when the water swellable layer absorbs water, so as to form apertures in the water swellable layer.

Based on the above, the invention provides a textile structure including a water swellable layer and a water permeable film layer, wherein the apertures form in the water swellable layer when absorbing water. Therefore, it is able to provide ventilation when the wearer sweats during exercise through the apertures formed in the water swellable layer. In addition, the wearer usually does not sweat during rest and there is no aperture formed in the water swellable layer, so the wearer is able to stay warm. On the other hand, at least part of the water permeable film layer extends to the incision, so the rough selvedge defect can be prevented at the incision area.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a cross-sectional schematic view of a textile structure according to the first embodiment of the invention.

FIG. 2-1 is a top view of a knitted textile structure according to the first embodiment of the invention.

FIG. 2-2 is a top view of a knitted textile structure when the water swellable layer absorbs water according to the first embodiment of the invention.

FIG. 3-1 is a top view of a woven textile structure according to the first embodiment of the invention.

FIG. 3-2 and FIG. 3-3 are top views of a woven textile structure when the water swellable layer absorbs water according to the first embodiment of the invention.

FIG. 4 is a cross-sectional schematic view of a textile structure according to the second embodiment of the invention.

FIG. 5 is a top view of a textile structure according to the third embodiment of the invention without water absorption.

FIG. 6 is a top view of a textile structure according to the third embodiment of the invention when the water swellable layer absorbs water.

FIG. 7 is a cross-sectional schematic view of a textile structure according to the fourth embodiment of the invention.

FIG. 8 is a top view of a textile structure according to the fourth embodiment of the invention.

FIG. 9 is a cross-sectional schematic view of a textile structure according to the fifth embodiment of the invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

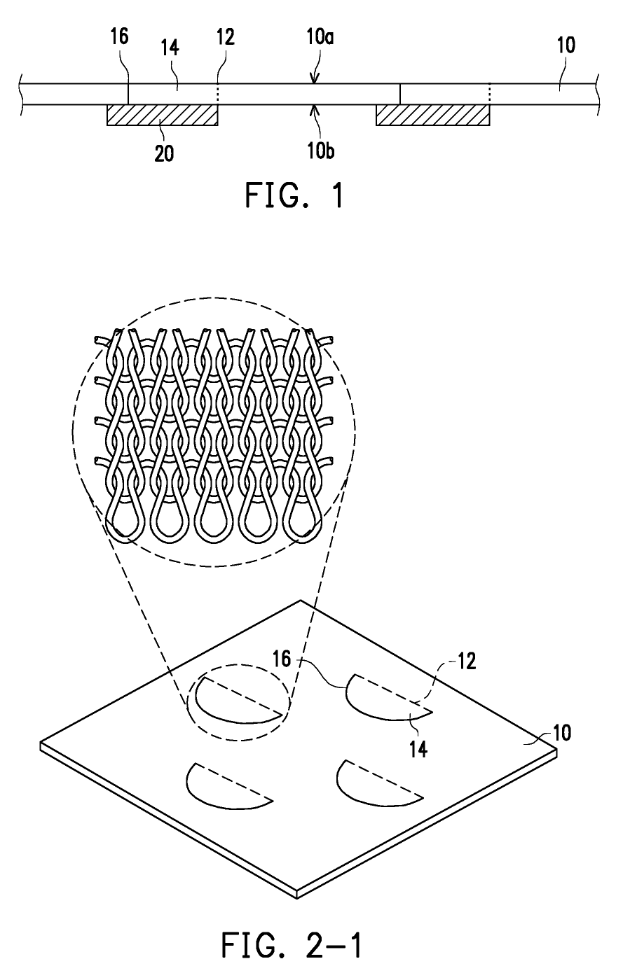

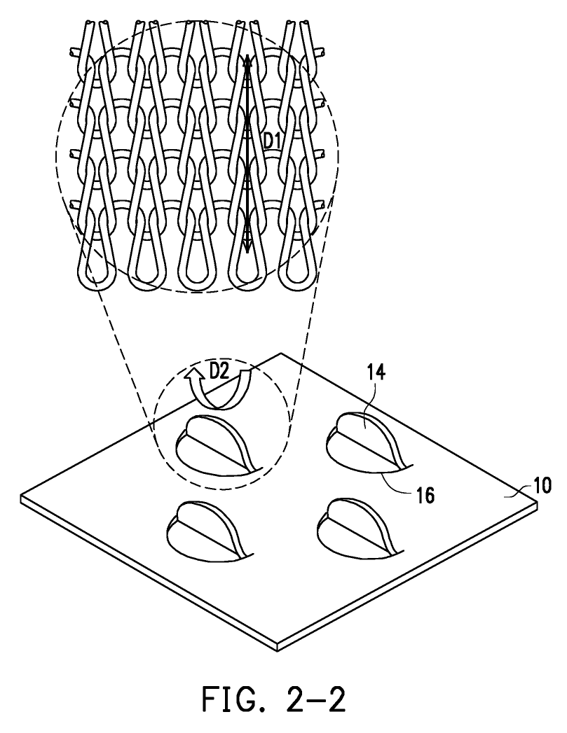

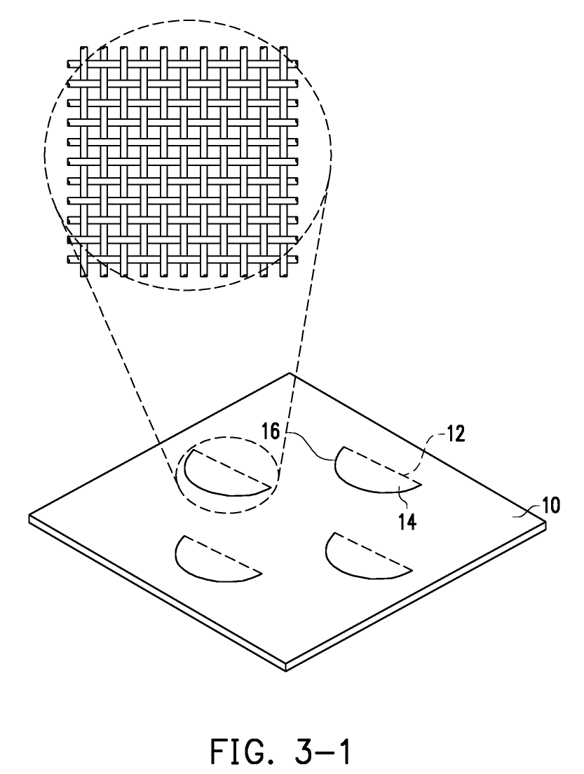

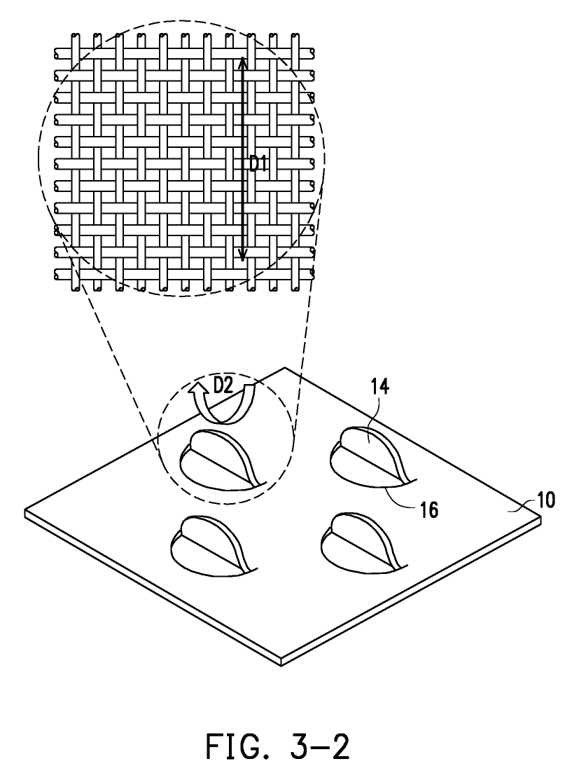

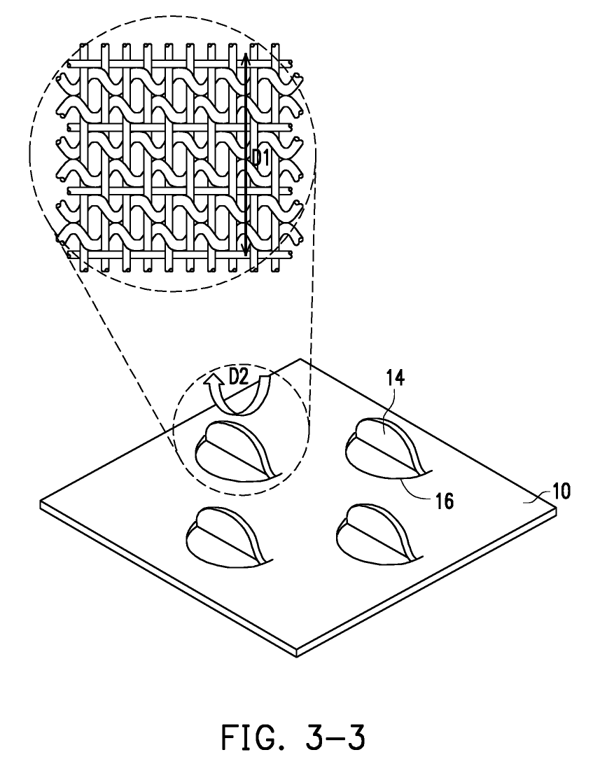

Referring to FIG. 1, FIG. 2-1, FIG. 2-2, FIG. 3-1, FIG. 3-2 and FIG. 3-3, in the present embodiment, the textile structure includes a water swellable layer 10 and a water permeable film layer 20. The water swellable layer 10 and the water permeable film layer 20 can be combined by a hot melting adhesion process, a sewing process, an ultrasonic process or a high frequency process, but the invention is not limited thereto. More particularly, the hot melting adhesion process may be performed at an adhesion temperature of 90° C. to 150° C. and a pressure range of 2 kg/cm² to 6 kg/cm² for 10 seconds to 60 seconds, for example.

In the present embodiment, the water swellable layer 10 has a first surface 10a and a second surface 10b opposite to each other, and has at least one fixing portion 12, at least one movable sheet 14 and at least one incision 16 which passes through the first surface 10a and the second surface 10b. The water swellable layer 10 may be preferably formed by water absorbing yarns with water swellable properties, and a water swellable direction D1 of the water absorbing yarns is preferably parallel to a curling direction D2 of the movable sheet 14, so as to control the curling direction of the movable sheet 14. However, the invention is not limited thereto, and the water swellable layer 10 can also be formed by a fabric which is plasma treated or coated with water swellable materials. Even though there are two movable sheets 14 and two incisions 16 shown in FIG. 1, the numbers of movable sheets 14 and incisions 16 are only exemplary, and the invention is not limited thereto. In other words, the number of movable sheets 14 and incisions 16 can be adjusted according to requirements and design. For example, the incision 16 may be formed by laser cutting, die cutting, cutting or jacquard, but the invention is not limited thereto. In addition, the textile structure may further include a decorative layer (not shown) for aesthetic effect, which can be disposed on the first surface 10a of the water swellable layer 10 corresponding to the movable sheet 14. The decorative layer can be used to control the curling degree of movable sheet 14 by adjusting the weight of decorative layer.

In the present embodiment, the water permeable film layer 20 is disposed on the second surface 10b of the water swellable layer 10 corresponding to the movable sheet 14. At least part of the water permeable film layer 20 extends to the incision 16, so the rough selvedge defect can be prevented at the incision 16 during cutting process. The material of the water permeable film layer 20 may include polyurethane (PU), thermoplastic polyurethane (TPU), thermoplastic elastomer/thermoplastic polyether ester elastomer (TPE/TPEE), pantothenyl ethyl ether (PEE) or polytetrafluoroethylene (PTFE), but the invention is not limited thereto. Even though there are two water permeable film layers 20 shown in FIG. 1, the number of water permeable film layers 20 is only exemplary, and the invention is not limited thereto. In other words, the number of water permeable film layers 20 can be adjusted according to requirements corresponding to the numbers of movable sheet 14 and incision 16.

Referring to FIG. 1, FIG. 2-2, FIG. 3-2 and FIG. 3-3, in the present embodiment, the movable sheet 14 curls and stretches away from the second surface 10b due to water swellable properties when the water swellable layer 10 absorbs water, so as to form apertures in the water swellable layer 10. The water swellable direction D1 of the water absorbing yarns which forms the water swellable layer 10 is preferably parallel to the curling direction D2 of the movable sheet 14, so as to control the curling direction of the movable sheet 14. FIG. 3-2 and FIG. 3-3 respectively show two different types of water absorbing yarns of woven textile structure when the water swellable layer 10 absorbs water. More particularly, when the wearer sweats, the sweat transmits to the water swellable layer 10 through the water permeable film layers 20. Therefore, it is able to provide ventilation when the wearer sweats during exercise through the apertures formed in the water swellable layer 10. The wearer usually does not sweat during rest and there is no aperture formed in the water swellable layer 10, so the wearer is able to stay warm. The apertures formation in the water swellable layer 10 is reversible, and also represents a visual three-dimensional performance which enhances aesthetic effect. The parameters including the water swellable degree and the fabric weight of the material of the water swellable layer 10, and the size of the incision 16 affect the curling degree of movable sheet 14. Therefore, the variation and combination of the aforementioned parameters can be adjusted according to different kinds of fitness trainings, so as to design clothes with different clothing ventilation and increased aesthetic effect.

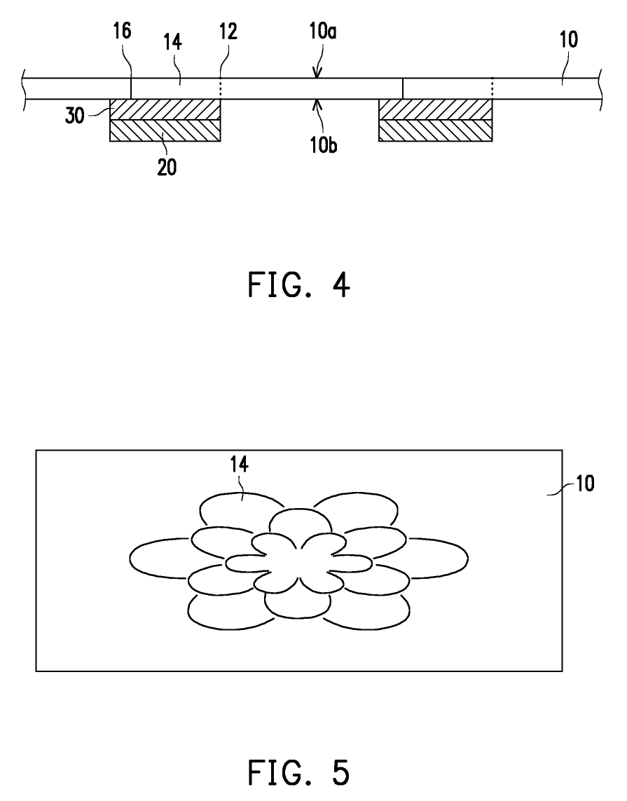

The embodiment shown in FIG. 4 is similar to the embodiment shown in FIG. 1, FIG. 2-1 and FIG. 2-2, and therefore the same components are represented by the same reference numerals and are not repeated herein. Referring to FIG. 4, the textile structure further includes a hot melt adhesive layer 30 disposed between the water swellable layer 10 and the water permeable film layer 20.

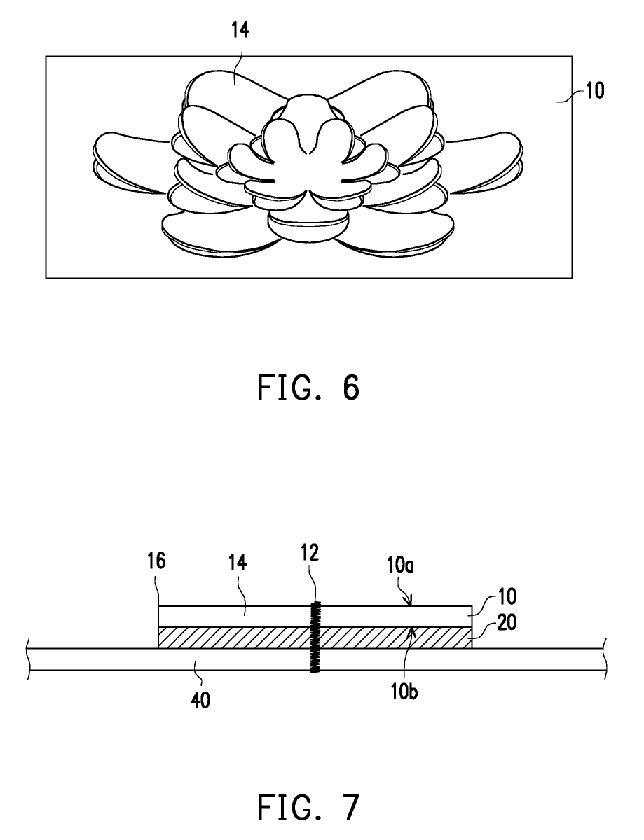

The embodiment shown in FIG. 5 and FIG. 6 is similar to the embodiment shown in FIG. 1, FIG. 2-1 and FIG. 2-2, and therefore the same components are represented by the same reference numerals and are not repeated herein.

Referring to FIG. 5 and FIG. 5, in the present embodiment, the number of movable sheets 14 and incisions of the water swellable layer 10 are adjusted according to requirements and design, so as to present a three-dimensional flower design by the apertures formed in the water swellable layer 10 during water absorption. Even though FIG. 5 and FIG. 6 show a flower design, different pattern and shape designs can be obtained by different movable sheets and incision design combine with the aforementioned parameters which affect the curling degree of movable sheet (the water swellable degree and the fabric weight of the material of the water swellable layer 10, and the size of the incision) for better aesthetic effect, and the invention is not limited thereto.

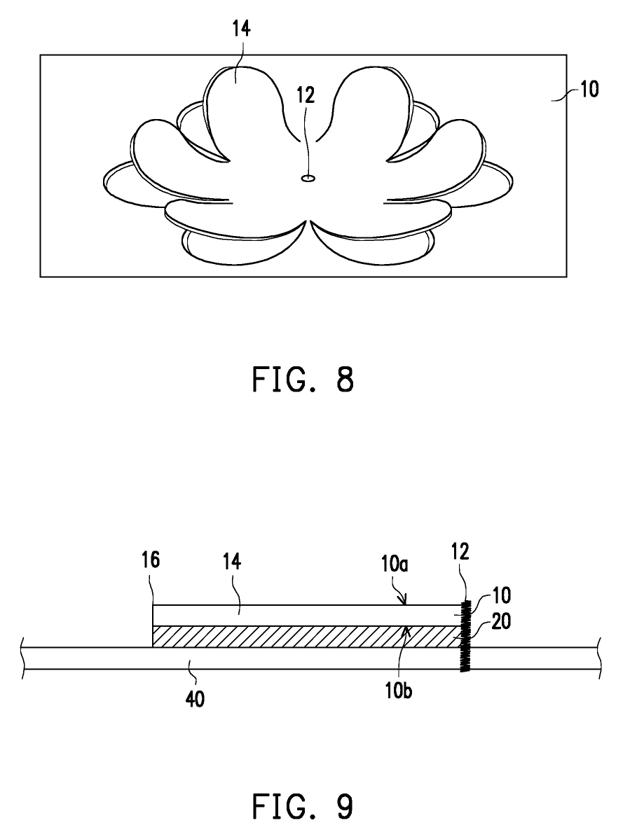

The embodiment shown in FIG. 7 and FIG. 8 is similar to the embodiment shown in FIG. 1, FIG. 2-1 and FIG. 2-2, and therefore the same components are represented by the same reference numerals and are not repeated herein.

Referring to FIG. 7, in the present embodiment, the textile structure further includes a mesh fabric layer 40 disposed on a surface of the water permeable film layer 20 away from the water swellable layer 10. The water swellable layer 10, the water permeable film layer 20 and the mesh fabric layer 40 are fixed in a vertical direction along the fixing portion 12 of the water swellable layer 10, and the fixing method may include sewing, adhesion, ultrasonic or high frequency method, but the invention is no limited thereto.

Referring to FIG. 7 and FIG. 8, the number of movable sheets 14 and incisions 16 of the water swellable layer 10 are adjusted according to requirements and design, so as to present a three-dimensional flower design by the apertures formed in the water swellable layer 10 during water absorption, wherein the fixing portion 12 can be the core of the flower. In the present embodiment, the textile structure further includes a mesh fabric layer 40, so the wearer's skin may not be directly exposed by the apertures formed in the water swellable layer 10 during sweat absorption, but the mesh fabric layer 40 may be exposed by the apertures. Therefore, better body temperature control and aesthetic effect can be obtained. Even though FIG. 7 and FIG. 8 show a flower design, different pattern and shape designs can be obtained by different movable sheets and incision design combine with the aforementioned parameters which affect the curling degree of movable sheet (the water swellable degree and the fabric weight of the material of the water swellable layer 10, and the size of the incision) for better aesthetic effect, and the invention is not limited thereto.

The embodiment shown in FIG. 9 is similar to the embodiment shown in FIG. 7, and therefore the same components are represented by the same reference numerals and are not repeated herein.

Referring to FIG. 9, the textile structure further includes a mesh fabric layer 40 disposed on a surface of the water permeable film layer 20 away from the water swellable layer 10. The difference is that, the fixing portion 12 is disposed near the center region of the water swellable layer 10 in the embodiment shown in FIG. 7. However, in the present embodiment, the fixing portion 12 is disposed at the edge of the water swellable layer 10. As a result, different pattern and shape designs can be obtained by adjusting the location of the fixing portion 12.

Based on the above, the invention provides a textile structure including a water swellable layer and a water permeable film layer, wherein the apertures form in the water swellable layer when absorbing water (sweat). Therefore, it is able to provide ventilation and improve wearing comfort when the wearer sweats during exercise through the aperture, and the wearer is able to stay warm during rest. On the other hand, at least part of the water permeable film layer extends to the incision, so the rough selvedge defect can be prevented at the incision area. In addition, the apertures formation in the water swellable layer is reversible, and also represents a visual three-dimensional performance which enhances aesthetic effect. The parameters which affect the curling degree of movable sheet (including the water swellable degree and the fabric weight of the material of the water swellable layer, and the size of the incision) can be adjusted according to different kinds of fitness trainings, so as to design clothes with different clothing ventilation. Different pattern and shape designs can be obtained by different movable sheets and incision design combine with the aforementioned parameters for better aesthetic effect.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

1. A textile structure, comprising:
a water swellable layer having a first surface and a second surface opposite to each other, and comprising at least one fixing portion, at least one movable sheet and at least one incision which passes through the first surface and the second surface; and
a water permeable film layer disposed on the second surface of the water swellable layer corresponding to the movable sheet, wherein at least part of the water permeable film layer extends to the incision,
wherein the movable sheet curls and stretches away from the second surface due to water swellable properties when the water swellable layer absorbs water, so as to form apertures in the water swellable layer.

2. The textile structure of claim 1, wherein the water swellable layer is formed by a fabric which is plasma treated or coated with water swellable materials.

3. The textile structure of claim 1, wherein the water swellable layer is formed by water absorbing yarns with water swellable properties, and a water swellable direction of the water absorbing yarns is parallel to a curling direction of the movable sheet.

4. The textile structure of claim 1, further comprising a hot melt adhesive layer disposed between the water swellable layer and the water permeable film layer.

5. The textile structure of claim 1, further comprising a mesh fabric layer disposed on a surface of the water permeable film layer away from the water swellable layer.

6. The textile structure of claim 5, wherein the water swellable layer, the water permeable film layer and the mesh fabric layer are fixed in a vertical direction along the fixing portion of the water swellable layer.

7. The textile structure of claim 6, wherein the water swellable layer, the water permeable film layer and the mesh fabric layer are fixed by sewing, adhesion, ultrasonic or high frequency method.

8. The textile structure of claim 1, further comprising a decorative layer disposed on the first surface of the water swellable layer corresponding to the movable sheet.

9. The textile structure of claim 1, wherein a material of the water permeable film layer includes polyurethane (PU), thermoplastic polyurethane (TPU), thermoplastic elastomer/thermoplastic polyether ester elastomer (TPE/TPEE), pantothenyl ethyl ether (PEE) or polytetrafluoroethylene (PTFE).

10. The textile structure of claim 1, wherein the water swellable layer and the water permeable film layer are combined by a hot melting adhesion process, a sewing process, an ultrasonic process or a high frequency process.

11. The textile structure of claim 10, wherein the hot melting adhesion process is performed at an adhesion temperature of 90° C. to 150° C. and a pressure range of 2 kg/cm² to 6 kg/cm² for 10 seconds to 60 seconds.
